(19) United States
(12) Patent Application Publication
(10) Pub. No.: US 2008/0145484 A1
(43) Pub. Date: Jun. 19, 2008

(54) Food marking tag

(76) Inventor: Leslie Michelle Haywood, Charleston, SC (US)

Correspondence Address: Leslie Michelle Haywood, 1646 Bull Creek Lane, Charleston, SC, 29414, US

(21) Appl. No.: 11/978,260

(22) Filed: Oct. 29, 2007

Related U.S. Application Data
(60) Provisional application No. 60/874,935, filed on Dec. 14, 2006.

(51) Int. Cl. A23L 1/00

(52) U.S. Cl. 426/87

(57) ABSTRACT

A removable, reusable food marking tag includes: (a) a head portion including a marking on an upper surface of the head portion; and (b) a spike portion including a substantially solid shaft and a plurality of projections projecting from the shaft, the shaft extending in a generally downward direction from a lower surface of the head portion; the length of each of the projections is less than a diameter of the shaft; the spike portion including a substantially pointed or curved tip at a lower end of the shaft; wherein, when the food marking tag is in use, the spike portion is inserted in the individual food item and the head portion remains adjacent an upper surface of the individual food item until the food marking tag is removed.

### CROSS REFERENCE TO RELATED DOCUMENT

Benefit is claimed under 35 USC 119(e) of provisional U.S. patent application No. 60/874,935, filed on Dec. 14, 2006.

### BACKGROUND OF THE INVENTION

1. Technical Field

The present invention relates generally to a removable food marking tag for inserting in and thus tagging pieces of meat or vegetables or other individual food items while the food items are being prepared and served.

2. Background Information

Requesting that a steak or other food item be cooked a certain way in a fine restaurant or at a backyard party can be a fruitless endeavor. A “well done” order may turn out to be rare when it arrives at the diner's table, or vice versa. The diner then must decide whether to send the food back to the kitchen and await its return, or just eat it. A dining experience that would otherwise have been pleasant can be sullied by such an occurrence.

Such a mistake is understandable, though, when one considers the difficulties inherent in organizing a number of pieces of meat or other foods in the kitchen. Even for the most organized chef, it is easy to forget which piece of meat is which, especially since the appearance of the meat changes as it cooks on a grill or in the oven. The more customers there are in the restaurant, the more inevitable it becomes that such a mistake will occur.

The same type of mistake occurs with even greater frequency at a backyard grill-out or other type of home party, where the cook is often not a professional. More cooks and participation by guests often add to the confusion. Many guests, though, are particular about their food. A rare steak that would delight one guest may repel another, for example. Food allergies or dietary needs can also pose a problem. It is vital that a guest with an allergy not be served the wrong food item.

The food marking tags of the present invention avoid such mistakes by custom marking each piece of meat or other food item. The chef or other kitchen staff places a differently marked food marking tag in each piece of meat or other food item early on, so that food item can be tracked throughout the cooking process. In a restaurant, the wait staff and kitchen staff can determine how a piece of meat should be or has been cooked by using a set of similarly marked food marking tags for each cooking designation (rare, medium rare, medium, medium well, and well done). One food marking tag is placed in each piece of meat to be cooked. If desired, the piece of meat and the food marking tag marking can be selected in advance by the guest. The food marking tag can be removed by the diner once the piece of meat or other food item has been served to him or her.

The removable food marking tags of the present invention also enhance the dining experience by permitting a guest to choose his or her “sign” ahead of time. At a party for example, the guests may be asked to each choose a tag from a set of differently marked food marking tags. At a Super Bowl party, for example, each food marking tag can be marked with a different team logo. The guests can chose the food marking tag with a marking depicting their favorite team, and then confirm that the piece of meat they requested is theirs by seeing the marking they chose on the food marking tag in the piece of meat. Appropriately marked food marking tags of the present invention can be purchased and used on different occasions each, such as Christmas, Thanksgiving, and Easter. The present food marking tags may be marked with seasonal symbols, such as an ice skate, snowflake, or mitten for use during winter parties.

The food marking tags of the present invention are washable and reusable, as desired. The food marking tags of the present invention are for use in any type of individual items of food, such as pieces of meat and individual vegetables, with a texture that will support the food marking tags. Such foods include hamburgers, pork chops, lamb chops, chicken, and fish, and portabella mushrooms, eggplants, zucchini, squash, and corn on the cob.

### BRIEF SUMMARY OF THE INVENTION

The present invention is a removable food marking tag for tagging individual pieces of meat or vegetables or other consumable food items during the preparation and serving of a number of the food items. The food marking tag of the present invention includes: (a) a head portion comprising a marking on an upper surface of the head portion; and (b) a spike portion comprising a substantially solid shaft and a plurality of projections projecting from the shaft, the shaft extending in a generally downward direction from a lower surface of the head portion; the length of each of the projections is less than a diameter of the shaft; the spike portion comprising a substantially pointed or curved tip at a lower end of the shaft. When the food marking tag is in use, the spike portion is inserted in the individual food item and the head portion remains adjacent an upper surface of the individual food item until the food marking tag is removed. The food marking tag is removable and reusable. The diameter, or length of the longest side, of the head portion is preferably about equal to the length of the spike portion.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a front perspective view of a food marking tag according to the present invention;

FIG. 2 is a rear perspective view of the food marking tag of FIG. 1;

FIG. 3 is a side elevational view of a food marking tag according to the present invention;

FIG. 4 is a side elevational view of a food marking tag according to the present invention;

FIG. 5 is a bottom plan view of the food marking tag of FIG. 4;

FIG. 6 is a side elevational view of a food marking tag according to the present invention;

FIG. 7 is a perspective view of a food marking tag according to the present invention;

FIG. 8 is a perspective view of a food marking tag according to the present invention;

FIG. 9 is a side perspective view of a food marking tag according to the present invention;

FIG. 10 is a perspective view of a food marking tag according to the present invention, shown on a steak;

FIG. 11 is a perspective view of a food marking tag according to the present invention, shown in use on a steak;

FIG. 12 is a side perspective view of a food marking tag according to the present invention;

FIG. 13 is a side perspective view of a food marking tag according to the present invention; and

FIG. 14 is a side elevational view of a food marking tag according to the present invention.

### DETAILED DESCRIPTION OF THE INVENTION

In the following description, like reference characters designate like or corresponding parts throughout the several views. Also, in the following description, it is to be understood that such terms as “front,” “inside,” and the like are words of convenience and are not to be construed as limiting terms. Referring in more detail to the drawings, the invention will now be described.

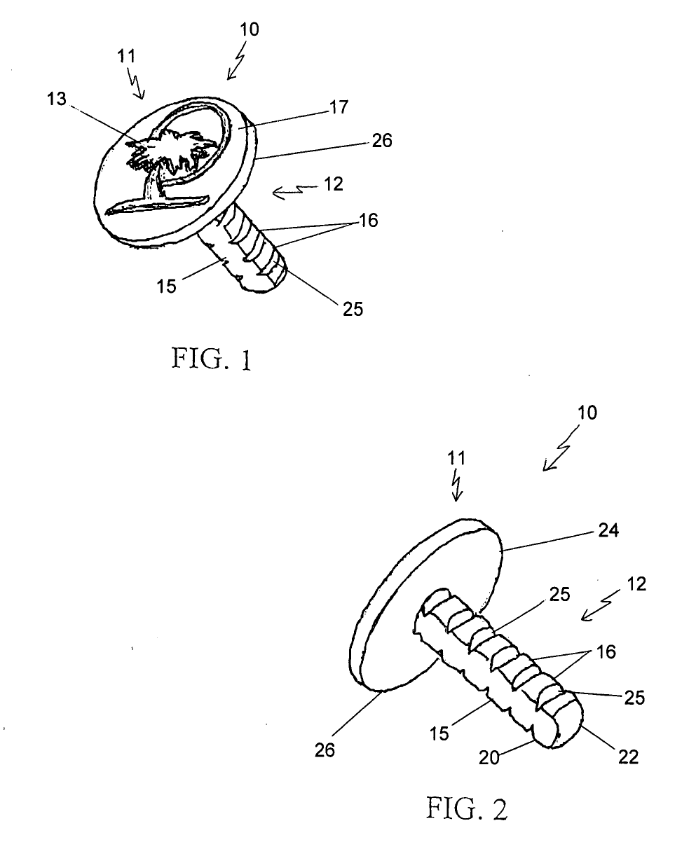

Referring to FIGS. 1 through 5, a food marking tag, which is generally referred to as 10, is insertable in a piece of meat or in individual vegetable or other consumable food items 14 for distinguishing the piece of meat or other food item 14 from similar items during preparation and serving of the food items. The food marking tag 10 includes a head portion 11 at the top of the food marking tag 10, and a spike portion 12, which may be peg-shaped, extending downwardly from a center of the lower surface of the head portion 11. The substantially vertically extending spike 12 is preferably substantially perpendicular to the substantially horizontal head portion, as seen in FIGS. 1 through 4. A marking 13 is imprinted, engraved, etched, cast, painted, printed, glued, or otherwise displayed on an upper surface 17 of the head portion 11. Each set of food marking tags 10 has a different marking 13, so as to distinguish an individual guest's food item 14 from similar looking food items of the other guests.

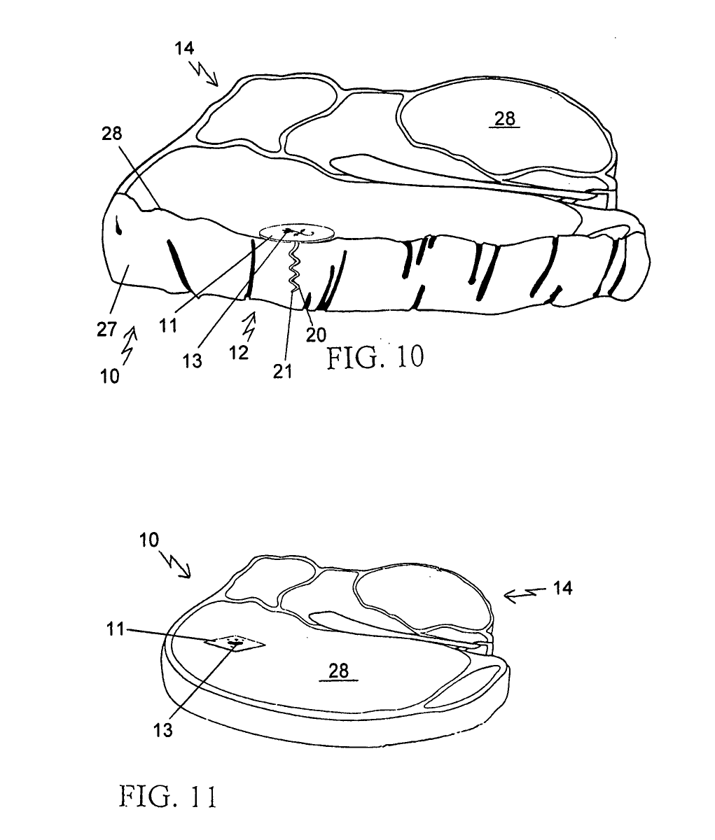

The spike portion 12 is insertable in a food item 14 in a generally upright fashion, with the spike portion 12 inserted into the interior 27 of the food item 14, and preferably with the lower surface 24 of the head portion 11 as seen in FIG. 10 contacting the upper surface 28 of the food item 14. In the steak food item 14 shown in FIG. 10, the spike portion 12 is fully embedded in the interior 27 of the food item 14. A spike portion 12 that is inserted halfway or more into the food item can also be used effectively. The head portion 11 is preferably substantially planar on its lower surface so that it fits closely against the top surface of the food item 14 when in use. The head portion 11 is preferably made of a safe, durable material that conducts heat, such as a metal. It has been found herein that the portion of the piece of meat or other food item 14 that lies beneath the head portion 11 cooks as evenly as the remainder of the upper food surface 28 and does not leave a mark when the food marking tag 10 is removed from the food item 14 prior to ingestion of the food item 14. Of course, the tag material must not adversely affect food quality or safety.

The upper and lower surfaces 17, 24 of the head portion 11 are preferably substantially planar, as seen in FIGS. 1, 3, and 4. The head portion 11 preferably comprises a substantially circular-shaped disk 26, as seen in FIGS. 1 through 7, although other shapes are also suitable. The preferred dime-sized disk 26 has a diameter of between about ¼ inch and about 1½ inches, which suits a great majority of individual food items 14.

As seen in FIGS. 1 through 4, the diameter of the disk 26 is about equal to the length of the spike portion 12 (and the shaft length). The ratio of a diameter of the disk 26 to the length of the spike portion 12 of the food marking tag 10 is preferably between about 2:1 and about 1:2, most preferably about 1:1. It has been found herein that this preferred ratio of disk diameter to spike length is sufficient to stay erect in the food item 14 and not work its way out of the food item during cooking. With this ratio, the food marking tag 10 is also unlikely to work its way into or through the bottom of the food item 14 during cooking. Each food marking tag 10 is preferably less than an inch in length and width.

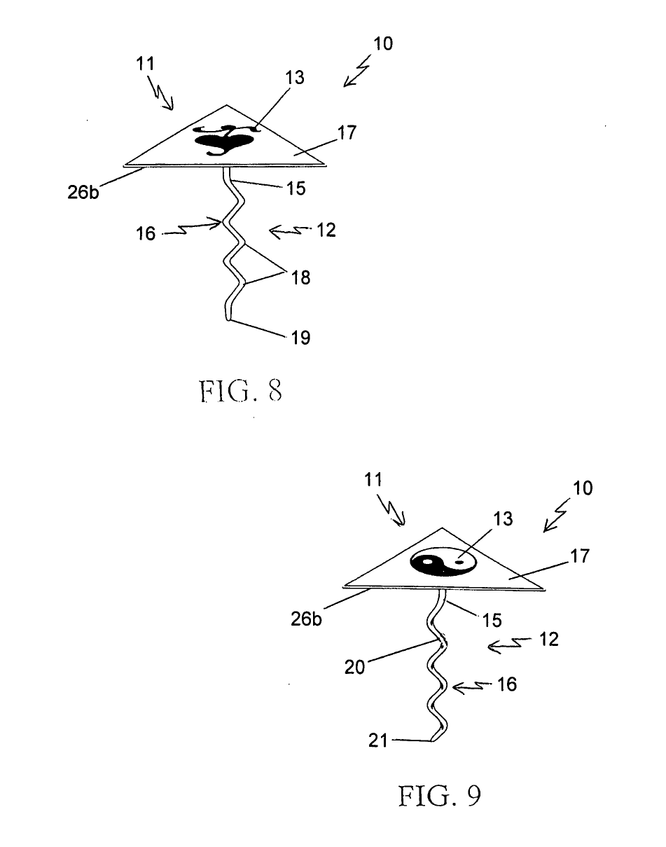

Referring to FIGS. 11 and 13, where the head portion 11 is substantially rectangular-shaped 26c, the length of the longest side of the substantially rectangular-shaped head 26c is preferably about equal to the length of the spike portion 12. The term “rectangular-shaped” is intended to include square-shaped. Where the head portion 11 is substantially triangular-shaped 26b as seen in FIGS. 8 and 9, the length of the longest side of the substantially triangular-shaped head 26b is preferably about equal to the length of the spike portion 12. The ratio of the length of the longest side of a substantially triangular-shaped head 26b or rectangular-shaped head 26c to the length of the spike portion 12 of the food marking tag 10 is preferably between about 2:1 and about 1:2, most preferably about 1:1. The maximum width of the substantially triangular-shaped head 26b or rectangular-shaped head 26c is preferably between about ¼ inch and about 1½ inches.

The spike portion 12 is also preferably made of a safe, durable, heat conducting material, such as a metal like aluminum, cast iron, or stainless steel (most preferred), so that the spike portion 12 conducts heat from the grill, oven, or other cooking means to the area immediately adjacent the spike portion 12 when the food marking tag 10 is in use. The spike portion 12 may or may not be made of the same material as the head portion 11. The food marking tag 10 herein maintains its character despite repeated heating and cooling. The food marking tag 10 material preferably withstands repeated cycles of heating to a temperature below about 500 degrees Fahrenheit (most preferably below about 400 degrees Fahrenheit) and cooling to a temperature above about 10 degrees Fahrenheit (most preferably above about 20 degrees Fahrenheit). The food marking tag 10 also does not rust or corrode after repeated washing and drying cycles, preferably in the utensil basket of an automatic dishwasher.

Suitable spike portions 12 for use herein include a solid shaft 15 and at least one projection 16 extending out from the shaft 15. The projections are small; each of the projections 16 has a length that is less than a (transverse) diameter of the shaft 15. The shaft 15 can be substantially circular-shaped or rectangular-shaped in transverse cross-section. For the shaft with a substantially square-shape as seen in FIG. 2, none of the projections 16 is longer than a width of the shaft 15 (or a side of the square cross-section).

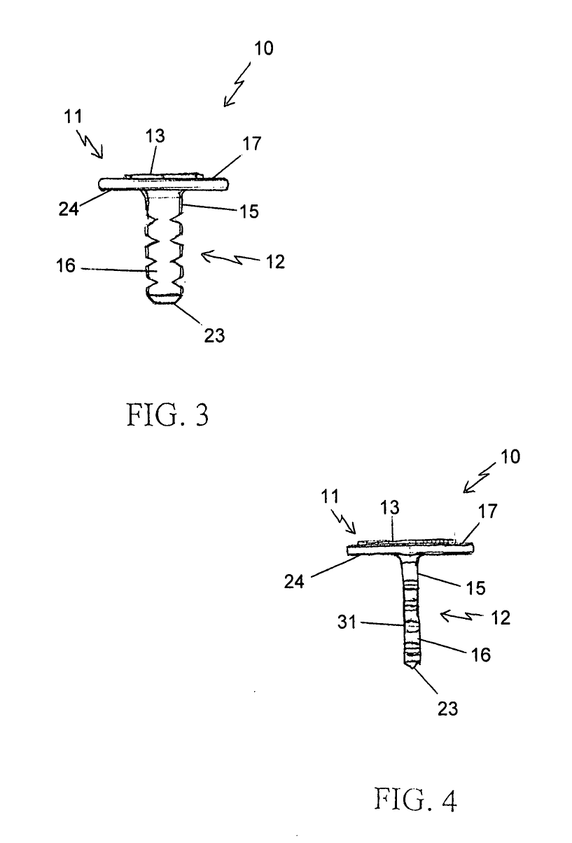

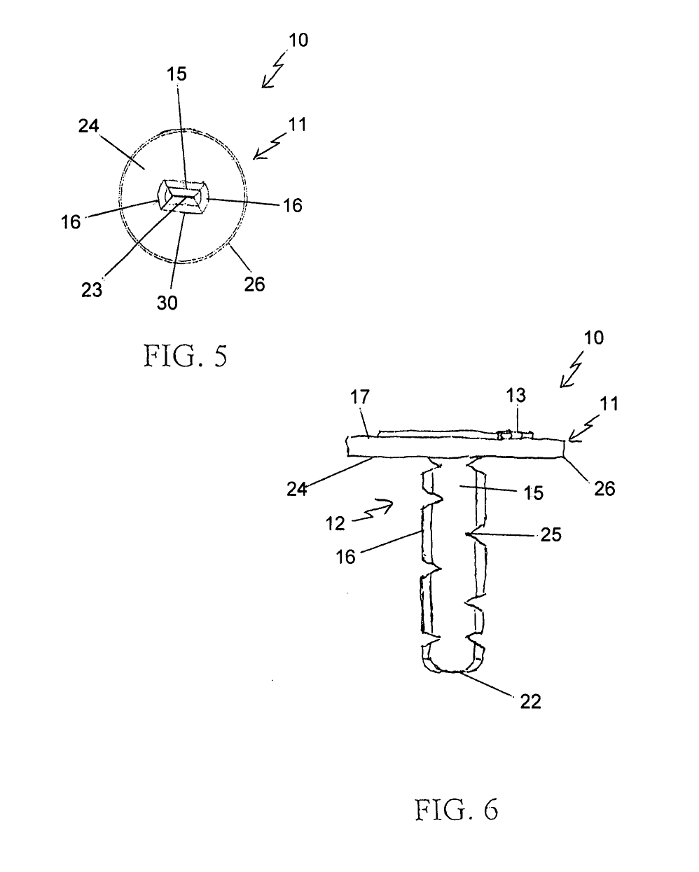

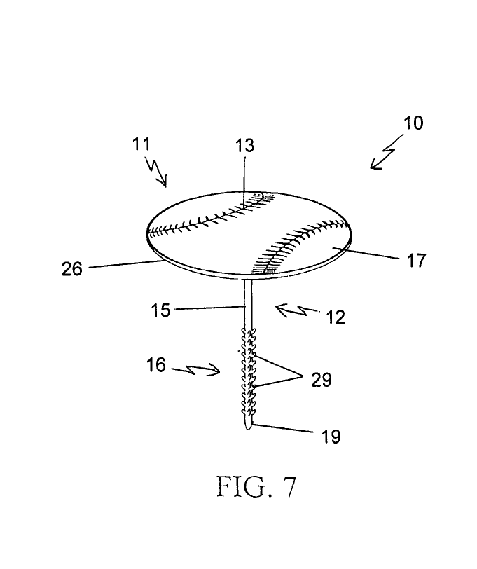

The food marking tag 10 depicted in FIGS. 1 through 4 includes a number of projections 16 on two opposite sides of the shaft. Each projection 16 lies between, and is formed by, about two substantially parallel indentations 25, or cuts, in the shaft. The other two sides 30 of the shaft 15, a transverse cross-section of which is square-shaped, do not have projections or indentations; they are substantially planar. As seen in FIG. 3, pairs of indentations 25 and projections 16 are directly opposite one another on the opposite sides of the shaft. In the food marking tag of FIG. 5, the indentations 25 are staggered and the projections 16 are irregularly shaped. The shaft 15 ends in a substantially elongated pointed tip 23 that is transversely elongated and pointed like the peak of an elementary house roof, as seen in FIGS. 7 through 9, or a curved tip 22 as seen in FIGS. 2 and 6. In the food marking tag 10 depicted in FIGS. 3 through 5, the substantially pointed elongated tip 23 is shaped as seen in FIG. 5.

Turning to the food marking tag 10 shown in FIG. 7, the projections 16 are a number of rows of spaced apart, individual barbs 29 projecting from the shaft around the periphery of a lower portion of the shaft 15. Here, the majority of the shaft 15 is cylindrical and substantially circular-shaped in transverse cross-section. The end portions of the barbs 29 preferably point generally outward (away from the shaft) and upward, most preferably at an angle of between about 40 and about 50 degrees relative to the generally horizontal upper food surface 28. It has been found herein that when the individual barbs 29 extend upward (and outward) as seen in FIG. 7, the chances that the food marking tag 10 will work itself back out of the food item 14 during food preparation and/or serving are minimal. The food marking tag 10 can nevertheless be pulled out by the guest or other end user prior to consumption of the food item 14. Alternatively, a number of projections extend substantially perpendicularly and randomly from around the shaft 15 rather than being in rows.

The lower end of the spike 12 is preferably a substantially straight, vertical, substantially cylindrical pointed end 19 for piercing the interior of the food item 14 where necessary. The pointed tip of the spike portion 12 pierces the upper surface 28 and then the interior 27 of the food item 14 as the food marking tag 10 is inserted, while the remainder of the spike portion 12 supports the food marking tag 10 in the interior 27 of the food item 14 (see FIG. 10).

Turning to the food marking tags 10 shown in FIGS. 8 and 9, the projections 16 may be a number of curves or zigzags in the shaft. The head portions 11 may be substantially triangular-shaped 26b as seen in FIGS. 8 and 9, or substantially rectangular in shape 26c, as seen in FIG. 13. Different markings 13 are imprinted or marked on the upper head surface 17. The preferred ratio of head length (on its longest side) to spike length is between about 2:1 and about 1:2, most preferably 1:1. The spike portion 12 may include a number of serpentine curves 20, as seen in FIG. 9, or a number of zigzag projections 18, as shown in FIGS. 8 and 10. Preferably, the food marking tags 10 include between about four and about eight of the serpentine curves 20 or zigzag projections 18.

As seen in FIG. 9, the pointed, curved lower end 21 of the spike portion 12 follows the overall serpentine curve. The spike portion 12 of FIG. 8 includes a substantially cylindrical, pointed lower end 19. The pointed lower ends 19, 21 pierce through the food item 14 as the food marking tag is inserted, and the serpentine curves 20 or zigzag projections 18 help maintain the food marking tag 10 in the interior of the food item 14 (see FIG. 10). The food marking tag 10 can be pushed straight down into the interior 27 of the food item 14 (see FIG. 11), or it can be screwed into the food item 14 where the spike portion 12 is curved like a corkscrew (see FIG. 9).

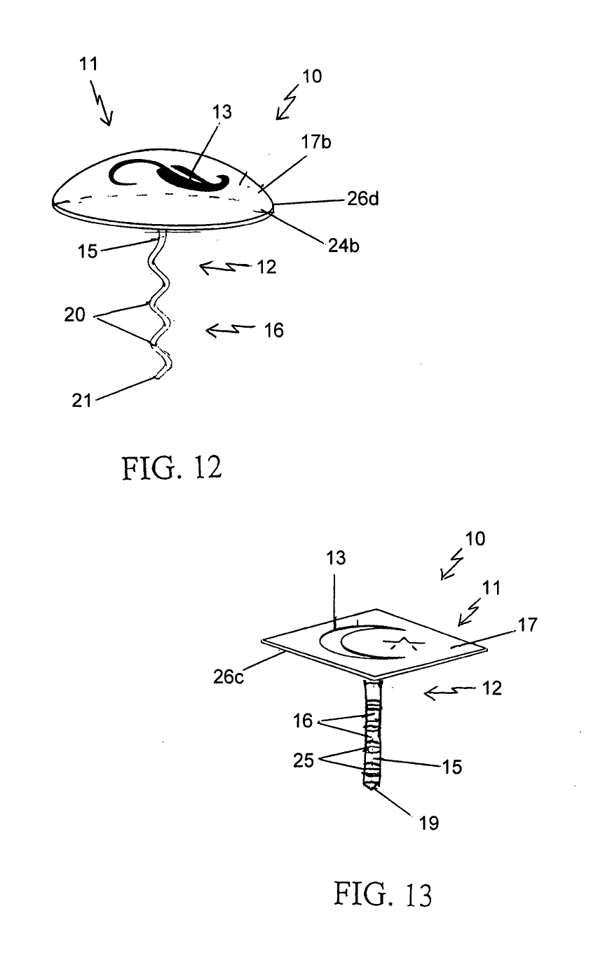

Turning to the food marking tags 10 shown in FIG. 12, the head portion is alternatively substantially dome-shaped 26d. The marking 13 can be printed on the upper surface 17b of the substantially dome-shaped head 26d, or within or under the dome. Along with a convex upper head surface 17b, the substantially dome-shaped head 26d comprises a substantially planar lower head surface 24, as seen in FIG. 2, or, alternatively, a correspondingly concave lower head surface 24b as indicated by hidden line in FIG. 12. A concave lower head surface 24b is believed to encourage even cooking of the surface of the food item 14 under the head portion, regardless of the material of the head portion 11. Any of the head portions 11 described herein can be attached to any of the spike portions 12 herein.

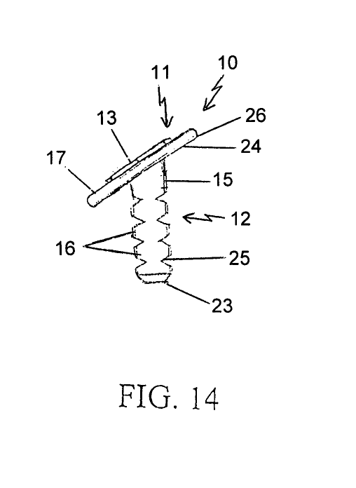

As seen in the food marking tag 10 of FIG. 14, the head portion 11 is alternatively tilted on the spike portion 12 of a food marking tag 10 (to one side or another). The head portion 11 is tilted relative to a central longitudinal axis of the spike 12 at an angle of between about 30 and about 60 degrees, most preferably about 45 degrees. Since the spike portion 12 is inserted generally vertically into the upper surface 28 of the food item 14 relative to the generally horizontal upper surface 28 of the piece of meat or other food item 14, the head portion 11 is angled relative to the food upper surface for maximum visibility. Since the head portion 11 is angled, a majority of it does not contact the upper surface 28 of the meat or other food item 14 when the tilted food marking tag 10 is in use. This permits the small portion of the meat or other food item 14 under the head portion 11 to be cooked at the same rate as the remainder of the meat or other food item. Any head portion 11 herein, regardless of its shape, can be tilted relative to any of the spike portions 12 described herein.

An angled disk 26 is easily viewed when a viewer is peering down (or up) at the food item 14. Angled disks can easily be viewed by a cook peering down into a floor-mounted oven to judge the cooking process, for example, or by a guest viewing a tray of cooked hamburger patties or other food items 14 on a kitchen counter. From the cook's viewpoint in front of the open oven, the cook can see angled disks 26 of the food marking tags 10 in each piece of meat or other food item 14. The cook can see, for example, that certain steaks 14 with food marking tags 10 marked “R” for “Rare” look ready to remove from the oven. A few minutes later, the cook can again peek into the oven and see that the steaks with food marking tags 10 marked “M” for “Medium”, for example, are ready to remove from the oven, and so forth. Of course, various markings can be used on top of the head portion 11 besides “R” or “M”. In the drawings herein, any head portion 11 can be joined with any spike portion 12. Thus, any one of the spike portions 12 depicted can have an angled head 11c on it.

The spike portions 12 are designed to stay in the varying textures of the individual food items 14, despite jostling of the food items 14 during food preparation (includes cooking), and/or serving. The tagged food items 14 may be, for example, moved around on the grill or stovetop with a cooking implement. The tagged food items 14 may be flipped over on the grill or in a frying pan, for example, to cook both sides without losing the food marking tag 10. A set of individual food items 14, each tagged with one food marking tag from a set of tags 10 may also be stacked on a serving plate. The spike portions 12 enable the food marking tags 10 to stay in the individual food item 14 until the tags 10 are removed by the end users. The spike portions 12 with their projections 16 maintain the food marking tags 10 in place in the relatively solid texture of a beef item, for example, or to remain upright and lodged in the relatively soft texture of a portabella mushroom or dessert item, for example (see FIGS. 1 and 2).

In addition to a collection of pieces of meat, the food marking tag 10 is useful for tagging a group of suitably sized vegetables, such as eggplants, large mushrooms, zucchini, squash, and corn cobs to be grilled. The tagged food items 14 can be cooked in the oven, on the stove, or on an indoor or outdoor grill, for example. The food marking tags 10 may indicate, for example, what marinade or seasoning has been used on that food item 14, such as spicy barbecue sauce, lemon pepper seasoning, or Cajun seasoning, depending on which marking has been assigned to that marinade or seasoning. Without the food marking tags of the present invention, a marinade or seasoning can be quite difficult to determine visually, since they often do not leave visible evidence behind on a steak or other food item 14. The food marking tags 10 may indicate, for example, whether monosodium glutamate, peanuts, milk, onion, garlic, salt, black pepper, or other additives that guests may be allergic to or may not want to consume have been used on a particular food item.

A set of food marking tags 10 can also be used for tagging a bag of rolls or desserts, such as a dozen cupcakes or a pan of brownies. The food marking tags 10 can be used, for example, for marking which cupcake or bread item does not contain raisins, nuts, table sugar, chocolate, dairy products, or other food ingredients that certain guests are allergic to, or simply dislike. The host or chef can indicate to the guests, or vice versa, in advance what the different markings 13 on the food marking tags 10 stand for (e.g., no nuts, medium rare, seasoned).

The food item 14 for use herein need not be cooked. The food marking tags 10 can be used in individual gelatin dessert molds, tins, or cups, for example, to indicate which have certain ingredients, such as pineapple or whipped cream.

In the set of food marking tags 10 for marking the group of individual food items, the spike portion 12 of each food marking tag 10 in the set is insertable in one of the group of individual food items 14 during cooking of the individual food item 14. The head portion 11 remains above an upper surface of the individual food item 14 during cooking, usually in contact with the surface of the food item 14. The food marking tags in a set are preferably substantially the same size as one another.

Markings 13 suitable for use herein include memorable designs or logos, such as sports team logos (with permission). The head portion 11 may include a circular-shaped disk 26 with baseball, soccer ball, or basketball type markings (see FIG. 7)1, or the head portion may be football-shaped, for example. These markings 13 are useful for sets of food marking tags 10 used for parties with sports related themes. Other suitable markings 13 include those relating to famous landmarks, such as the Statue of Liberty, or national flags. Suitable markings also include designs found in nature, such as a leaf (see FIG. 12), a palm tree (see FIG. 1), a moon and star (see FIG. 13), and a flower (see FIG. 10). Suitable markings 13 also include simple designs, such as a heart (see FIGS. 3 and 12), and a yin and yang symbol (see FIG. 9). Such markings 13 are useful for food marking tags 10 used during Valentine's Day, Father's Day, Christmas, Hanukkah, or New Year's Eve themed parties. The head portion 11 need not have a circular, triangular, or rectangular periphery; it can be star-shaped, moon-shaped, heart-shaped, flower-shaped, etc. The set of tags, then, would include food marking tags 10 with different shaped head portions that can easily be recognized by the guest as denoting their food.

From the foregoing it can be realized that the described device of the present invention may be easily and conveniently utilized as a food marking tag. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 food marking tag
11 head portion
12 spike portion
13 tag marking
14 food item
15 shaft
16 projection
17 upper head surface
18 spike zigzags
19 cylindrical pointed lower end
20 serpentine curves
21 substantially pointed, curved lower end
22 curved tip
23 substantially elongated pointed tip
24 lower head surface
25 indentations
26 disk
26b substantially triangular head
26c substantially rectangular head
26d substantially dome-shaped head
27 food item interior
28 food item surface
29 barbs
30 planar opposite sides of shaft

What is claimed is:

1. A food marking tag for marking an individual food item, the food marking tag comprising:
(a) a head portion comprising a marking on an upper surface of the head portion; and
(b) a spike portion comprising a substantially solid shaft and a plurality of projections projecting from the shaft, the shaft extending in a generally downward direction from a lower surface of the head portion; the length of each of the projections is less than a diameter of the shaft; the spike portion comprising a substantially pointed or curved tip at a lower end of the shaft; wherein, when the food marking tag is in use, the spike portion is inserted in the individual food item and the head portion remains adjacent an upper surface of the individual food item until the food marking tag is removed, the food marking tag being removable and reusable.

2. The food marking tag according to claim 1, wherein the spike portion is substantially perpendicular to the head portion, the spike portion being substantially vertically oriented in relation to the substantially horizontally oriented head portion, the lower surface of the head portion contacting the upper surface of the individual food item when the food marking tag is in use.

3. The food marking tag according to claim 1, wherein a ratio of a diameter of a substantially circular-shaped disk of the head portion to the length of the spike portion is between about 2:1 and about 1:2.

4. The food marking tag according to claim 1, wherein the shaft is substantially square-shaped in transverse cross-section, and none of the projections is longer than a width of the shaft.

5. The food marking tag according to claim 1, wherein the head portion is angled on the spike portion at an angle of between about 30 and about 60 degrees, measuring between a longitudinal axis of the head portion and a longitudinal axis of the spike portion.

6. The food marking tag according to claim 1, wherein each of the projections is attached at one end to the shaft, and each projection comprises a substantially pointed tip at an opposite end of the projection.

7. The food marking tag according to claim 1, wherein the head portion is substantially dome-shaped, the lower surface of the head portion being convex.

8. The food marking tag according to claim 4, wherein each projection is formed by substantially parallel indentations in the shaft, the projections being on opposite sides of the shaft.

9. The food marking tag according to claim 8, wherein each opposite side of the shaft comprises a row of the projections, which are generally uniform and stacked on one another in each row, the remaining two opposite sides of the shaft being substantially planar.

10. The food marking tag according to claim 8, wherein the indentations are on either side of the projections and are staggered, the projections being irregular in shape, the spike portion comprising a substantially elongated, pointed tip.

11. The food marking tag according to claim 8, wherein the head portion is substantially rectangular-shaped, a length of a longest one of the sides of the head portion being about equal to the length of the spike portion, the head portion comprising a substantially planar upper surface and a substantially planar lower surface.

12. The food marking tag according to claim 1, wherein the projections are rows of spaced apart barbs projecting from the shaft around a periphery of a portion of the shaft.

13. The food marking tag according to claim 12, wherein each of the projections is attached at one end to the shaft, the projections being substantially same-sized and spaced apart, each projection extending in an upward and outward direction from the shaft, a length of the projection exceeding a width of the shaft.

14. The food marking tag according to claim 1, wherein the projections are a plurality of serpentine curves, the shaft further comprising a pointed, curved lower end.

15. The food marking tag according to claim 1, wherein the projections comprise a plurality of zigzags, the spike portion further comprising a substantially cylindrical, pointed lower end.

16. The food marking tag according to claim 2, wherein the head portion is substantially triangular in shape, the ratio of a length of a longest side of the substantially triangular-shaped head portion to the length of the spike portion being between about 2:1 and about 1:2.

17. The food marking tag according to claim 4, wherein the head portion is disk-shaped, and the shaft is square-shaped in transverse cross-section, each projection being formed by substantially parallel indentations in the shaft, the projections being on opposite sides of the shaft.

18. The food marking tag according to claim 4, wherein the projections are same-sized and spaced apart, each projection extending substantially perpendicularly from a side of the shaft.

19. A set of a plurality of food marking tags for marking a group of individual food items, each of the food marking tags comprising: (a) a head portion with a marking on an upper surface of the head portion, each food marking tag comprising a different marking from the other food marking tags in the set; and (b) a spike portion extending in a generally downward direction from a lower surface of the head portion, the spike portion comprising a substantially solid shaft and a plurality of projections projecting from the shaft; wherein the spike portion of each food marking tag in the set is insertable in one of the individual food items during cooking of the individual food item, the head portion remaining above an upper surface of the individual food item during cooking, the food marking tags in the set being substantially the same size as one another.

20. The food marking tag set according to claim 19, wherein the shaft of each food marking tag in the set is square-shaped in transverse cross-section, each projection being formed by substantially parallel indentations in the shaft, the projections being on opposite sides of the shaft, the shaft comprising a substantially pointed or curved tip at its lower end.
